(19) United States
(12) Patent Application Publication
(10) Pub. No.: US 2026/0212344 A1
(43) Pub. Date: Jul. 23, 2026

(54) APPARATUS, SYSTEMS AND METHODS FOR DATA PROCESSING

(71) Applicant: Covantis SA, Geneva (CH)

(72) Inventors: Christophe Hannon, Geneva (CH); Guillaume Perreau, Geneva (CH); Mateusz Furman, Geneva (CH); Jose Gallegos, Geneva (CH); Lennart Overkamp, Geneva (CH)

(21) Appl. No.: 19/568,556

(22) Filed: Mar. 16, 2026

Related U.S. Application Data
(63) Continuation of application No. 19/145,121, filed on Dec. 23, 2024.

(51) Int. Cl. G06Q 20/38; G06Q 30/0601

(52) U.S. Cl. CPC G06Q 20/38; G06Q 30/0635

(57) ABSTRACT

A data processing apparatus comprises processing circuitry to receive, from client devices, transaction data indicative of properties for future transactions for exchange of physical items between entities, wherein the transaction data for a respective transaction is indicative of at least: identifiers for two entities; a type and/or name for an item to be exchanged; a quantity for the item to be exchanged; and a location and time for the transaction, analyse the transaction data and generate a group of transactions corresponding to a same item type, input the group of transactions corresponding to the same item type to a loop identifier model to identify a transaction loop comprising at least three respective transactions from the group of transactions, generate notification data indicative of the transaction loop, and output the notification data to one or more of the client devices.

### BACKGROUND OF THE INVENTION

The present invention relates to apparatus, systems and methods for data processing. In particular, the present invention relates to apparatus, systems and methods for processing of transaction data for exchange of physical items.

Exchange of physical items between entities for purposes such as domestic and international trade is a key part of the global economy. Transportation of physical items over land, sea and air is a significant source of emissions of carbon dioxide and other greenhouse gases. Efforts to reduce emissions for mitigating climate change and improving air quality are a key global issue.

Agreements whereby physical items are to be exchanged between entities are typically agreed in advance of execution of such agreements and may in some cases be agreed, days, weeks or even months in advance of an execution date. For physical items, such as commodities and other similar items, entities can often have a number of open agreements in place at any given time and some entities may operate as sellers of items for some agreements and also as buyers of those items for other agreements.

The numbers of entities and numbers of individual exchanges can often give rise to situations in which some entities act as sellers for items whist also acting as buyers for those same items. The agreements in place can in some cases form a closed loop that starts and ends with a same entity without this being known by any of the entities, and potentially not being known even upon or after execution of the agreements. Execution of agreements including such closed loops results in items being unnecessarily transported and contributes to unnecessary carbon emissions and environmental impact, as well as potentially contributing to unnecessary logistics and supply chain management considerations.

It is in this context that the present invention arises.

### SUMMARY OF THE INVENTION

According to an aspect of the disclosure, a data processing apparatus is configured to: receive, from client devices, transaction data indicative of properties for future transactions for exchange of physical items between entities, wherein the transaction data for a respective transaction is indicative of at least: identifiers for two entities; a type and/or name for an item to be exchanged; a quantity for the item to be exchanged; and a location and time for the transaction; analyse the transaction data and generate a group of transactions corresponding to a same item type; input the group of transactions corresponding to the same item type to a loop identifier model to identify at least one transaction loop comprising at least three respective transactions from the group of transactions; generate notification data indicative of the transaction loop; and output the notification data to one or more client devices.

The data processing apparatus may be configured to output the notification data to a given client device in dependence on whether the given client device is associated with an entity having at least one respective transaction included in the transaction loop.

The data processing apparatus may perform one or more filtering operations for the group of transactions to remove at least one transaction from the group of transactions prior to the group of transactions being input to the loop identifier model.

The data processing apparatus may be configured to: analyse the group of transactions to identify a set of two transactions involving bi-directional exchange between a same two entities; summarise the set of two transactions as a single transaction involving unidirectional exchange, or cancel the set of two transactions when the set of two transactions have matching quantities; update the group of transactions to replace the set of two transactions with the single transaction, or remove the set of two transactions when the set of two transactions have matching quantities, to thereby obtain an updated group of transactions corresponding to the same item type; and input the updated group of transactions to the loop identifier model.

The data processing apparatus may be configured to: analyse the group of transactions and identify at least one pair of matching transactions; and update the group of transactions corresponding to the same item type in response to identifying matching transactions to remove a respective transaction of the pair of matching transactions or combine the pair of matching transactions into a respective transaction.

The data processing apparatus may be configured to: analyse the group of transactions and identify transactions that are partially matching; and report transactions that are partially matching for user assessment.

The loop identifier model may be operable to identify two or more transaction loops each comprising at least three respective transactions from the group of transactions corresponding to the same item type.

The data processing apparatus may be configured to select a respective transaction loop from the two or more transaction loops and generate notification data indicative of the respective transaction loop.

The data processing apparatus may be configured to select a respective transaction loop from the two or more transaction loops in dependence on one or more properties for the two or more transaction loops, wherein the one or more properties comprise at least a quantity associated with a respective transaction having a smallest quantity in each of the transaction loops.

The data processing apparatus may be configured to: determine a quantity associated with a respective transaction having a smallest quantity in each of the two or more transaction loops; and select, from the two or more transaction loops, the respective transaction loop for which the respective transaction having the smallest quantity is greatest.

The one or more properties may further comprise at least one of: a total number of entities associated with a respective transaction loop; and a total number of entities associated with the respective transaction loop that do not have a registered account with an online service provided by the data processing apparatus.

The identified transaction loop may be selected from two or more transaction loops identified by the loop identifier model based on one or more user inputs or based on automatic selection by the data processing apparatus, and the data processing apparatus may be configured to: update the group of transactions corresponding to the same item type in dependence on the identified transaction loop to obtain an updated group of transactions; input the updated group of transactions to the loop identifier model to identify a next transaction loop comprising at least three respective transactions from the updated group of transactions; and generate notification data indicative of the next transaction loop, wherein the identified transaction loop and the next transaction loop are not mutually exclusive.

The data processing apparatus may be configured to: determine a quantity associated with a respective transaction having a smallest quantity in the identified transaction loop; update each respective transaction included in the identified transaction loop to remove the quantity from the respective transactions and thereby obtain a modified set of respective transactions; and update the group of transactions to replace the respective transactions included in the identified transaction loop with the modified set of respective transactions and thereby obtain the updated group of transactions for input to the loop identifier model for identifying the next transaction loop.

The data processing apparatus may be configured to automatically update the group of transactions to obtain the updated group of transactions and input the updated group of transactions to the loop identifier model to identify the next transaction loop.

The data processing apparatus may be configured to repeat the operations of updating the group of transactions and inputting the updated group of transactions to the loop identifier model to identify further transaction loops.

The data processing apparatus may be configured to update the group of transactions to obtain the updated group of transactions and input the updated group of transactions to the loop identifier model in response to receiving user confirmation for the identified transaction loop.

In response to receiving user rejection for the identified transaction loop, the data processing apparatus may be configured to: generate second notification data indicative of another transaction loop; and output the second notification data to one or more of the client devices.

A number of transaction loops identifiable by the loop identifier model for a set of input transaction data may be limited to a threshold number of transaction loops, and/or a running time for the loop identifier model to identify transaction loops for a set of input transaction data may be limited to a threshold time duration.

The data processing apparatus may be configured to: receive first transaction data uploaded from a first client device associated with a first entity, store the first transaction data to storage circuitry, and generate a first user interface accessible to the first client device for displaying the first transaction data; and receive second transaction data uploaded from a second client device associated with a second entity, store the second transaction data to the storage circuitry, and generate a second user interface accessible to the second client device for displaying the second transaction data.

The data processing apparatus may be configured to update the first transaction data to add new transactions and/or modify transactions in response to user inputs via the first user interface, and wherein the processing circuitry is configured to update the second transaction data to add new transactions and/or modify transactions in response to user inputs via the second user interface.

In response to an identified transaction loop comprising at least one transaction involving the first entity and at least one transaction involving the second entity, the data processing apparatus may be configured to allow access via each of the first user interface and the second user interface to the notification data indicative of the identified transaction loop.

For each entity involved in the identified transaction loop and having a registered account with an online service provided by the data processing apparatus, the data processing apparatus may be configured to allow access to the notification data indicative of the identified transaction loop via a user interface associated with that entity.

The notification data may comprise a selectable user interface element for confirming the identified transaction loop, and the data processing apparatus may be configured to generate confirmation data for the identified transaction loop in response to receiving confirmation from each entity involved in the identified transaction loop having a registered account with the online service.

In response to an identified transaction loop comprising at least the first entity and the second entity, the data processing apparatus may be configured to generate an online chat for enabling message exchange between at least the first entity and the second entity.

The data processing apparatus may be configured to analyse the transaction data and generate a plurality of respective groups of transactions each corresponding to a different item type, and input each of the plurality of groups of transactions to the loop identifier model to identify a transaction loop for each of the plurality of groups of transactions.

The group of transactions may comprise transactions each corresponding to a same item type, a same location, and a time corresponding to a same time range.

According to another aspect of the disclosure, a computer-implemented method comprises: receiving, from client devices, transaction data indicative of properties for future transactions for exchange of physical items between entities, wherein the transaction data for a respective transaction is indicative of at least: identifiers for two entities; a type or name for an item to be exchanged; a quantity for the item to be exchanged; and location and time information for the transaction; analysing the transaction data and generating a group of transactions corresponding to a same item type; inputting the group of transactions corresponding to the same item type to a loop identifier model to identify at least one transaction loop comprising at least three respective transactions from the group of transactions; generating notification data indicative of the transaction loop; and outputting the notification data to one or more of the client devices.

According to another aspect of the disclosure, a computer program comprises instructions which, when executed by a computer, cause the computer to perform any of the above methods.

Various aspect and features of the present invention are defined in the appended claims and within the text of the accompanying description. Example embodiments include at least systems, apparatus, methods, computer programs, and machine-readable non-transitory storage mediums which store such computer programs.

### BRIEF DESCRIPTION OF THE FIGURES

In order that the present disclosure may be more readily understood, embodiments thereof will now be described, by way of example only, with reference to the accompanying drawings, in which:

FIG. 1 is a schematic diagram illustrating a data processing apparatus accessible to clients via a network.

FIG. 2 is a schematic diagram illustrating a data processing apparatus in accordance with embodiments of the disclosure.

FIG. 3 is a schematic flowchart illustrating a method for processing transaction data.

FIG. 4 is a schematic flowchart illustrating a method comprising performing one or more filtering operations for a group of transactions.

FIG. 5 is a schematic flowchart illustrating a method for identifying a transaction loop and updating transaction data for identifying a further transaction loop.

FIG. 6 is a schematic flowchart illustrating an example of receiving user confirmation for an identified transaction loop.

FIG. 7 is a schematic flowchart illustrating an example of receiving user rejection for an identified transaction loop.

FIG. 8 is a schematic flowchart illustrating an example of identifying transaction loops in which the loop identifier model runs according to one more set thresholds.

FIG. 9 is a schematic diagram illustrating an example system comprising the data processing apparatus and three clients.

FIGS. 10a and 10b are schematic diagrams illustrating examples of graphs including three nodes and edges connecting the nodes.

### DETAILED DESCRIPTION OF THE DISCLOSURE

The techniques of the present disclosure relate to apparatus, systems and methods for processing of transaction data for exchange of physical items.

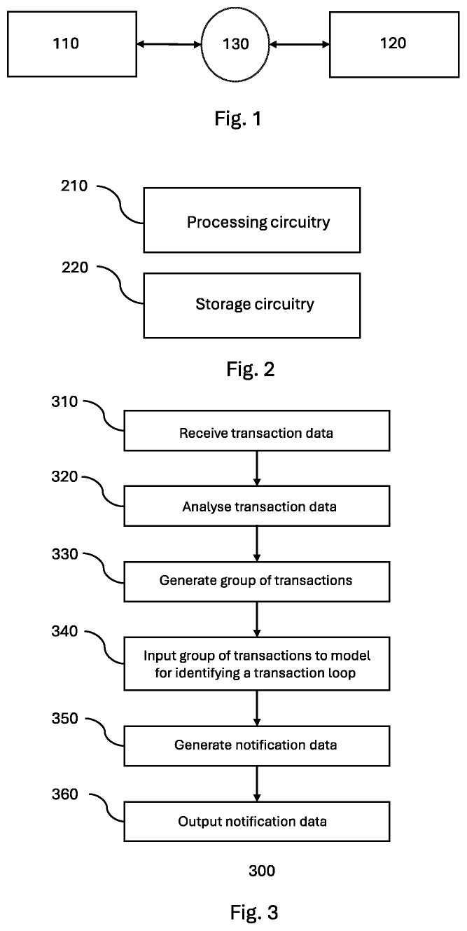

FIG. 1 schematically illustrates an example arrangement in which a data processing apparatus 110 is accessible to one or more client devices 120 via one or more networks 130. FIG. 1 provides an example in which the data processing apparatus is capable of communication with client devices via one or more communications networks for receiving transaction data and providing outputs to clients. In the techniques of the present disclosure, the data processing apparatus may receive inputs from any suitable number of clients and the number of clients is not particularly limited. The term client device may refer to any of local machine(s), client node(s), client machine(s), client computer(s), endpoint(s), endpoint node(s) in communication with the apparatus 110 via one or more networks 130. In some examples, client devices may include general purpose computing devices such as laptops, desktop computers, smartphone devices, tablet devices, smartwatches and so on.

The data processing apparatus 110 and client devices 120 may communicate using any suitable communications technology. The data processing apparatus and clients may communicate via one or more Wide Area Networks (WAN), such as the Internet. For example, the data processing apparatus may be a remote server accessible via potentially large number of clients via the Internet.

In some embodiments of the disclosure, web browser techniques and/or email techniques may be used for client interaction with the data processing apparatus. For example, clients may communicate transaction data to the data processing apparatus 110 using one or more emails and/or one or more parameters specified via a web browser. In some embodiments of the disclosure, the data processing apparatus may have an associated browser user interface for allowing users to input transaction data and communicate the input transaction data for processing by the data processing apparatus. For example, the data processing apparatus may provide an online service accessible to clients via a communications network (e.g. the Internet) and clients may be able to register an account with the online service to upload transaction data for processing by data processing apparatus. Clients may upload transaction data in an on-going manner and may modify, update, and add new transaction data for processing by the by data processing apparatus. More generally, various possibilities may be used for providing transaction data to the data processing apparatus 110. In some examples, application programming interface (API) integration techniques may be used for communication of transaction data and notification data between the data processing apparatus 110 and one or more client devices.

Transaction data indicative of properties for future transactions for exchanging physical items (e.g. goods) between entities (e.g. users, organisations, businesses and so on) can thus be received by the data processing apparatus and processed according to the techniques discussed below. Transaction data can be received from a potentially large number of clients (e.g. of the order of tens, hundreds or even thousands). The data processing apparatus 110 may thus provide an online service (e.g. online platform) for receiving transaction data from a plurality of sources and the transaction data can be gathered and processed according to the techniques to be discussed below. In some examples, the data processing apparatus may periodically process the transaction data. For example, transaction data accessible to the data processing apparatus (e.g. stored by storage circuitry accessible to the data processing apparatus and/or provided as part of the data processing apparatus) may be processed on a periodic basis such as once per hour, once per day, once per week (or twice per week) and so on. In some examples, processing of transaction data by the data processing apparatus may be triggered in response to receiving transaction data from a client (which may correspond to a modification of previously uploaded transaction data and/or uploading of new transaction data for one or mor new transactions).

FIG. 2 is a schematic diagram illustrating the data processing apparatus 110 in more detail. The data processing apparatus 110 comprises processing circuitry 210 and storage circuitry 220. In some examples, the processing circuitry 210 and the storage circuitry 220 may be provided as part of separate devices. For example, the processing circuitry 210 may be operable to access the storage circuitry 220 via one or more wired and/or wireless communications networks to access and process data stored by the storage circuitry 210. In some examples, the storage circuitry may be a datastore (e.g. database) for storing transaction data. In some examples, the functionality of the data processing apparatus may be implemented using one or more processing devices and may be implemented in a distributed manner. In some examples, the functionality of the data processing apparatus 110 may be implemented using one or more backend servers and data stores. Any of the processing circuitry 210 and the storage circuitry 220 may be distributed across as number of devices at potentially different locations. In some examples, so-called cloud computing techniques may be used.

More generally, the storage circuitry 220 can be operable to store transaction data received from clients, and the processing circuitry 210 is operable to access and process the transaction data. The processing circuitry 210 may comprise one or more CPUs, GPUs and/or DPUs or any combination thereof, for example, which may be part of a same device (e.g. server) or a combination of processing devices (e.g. two or more servers). The storage circuitry 220 may use any suitable hardware for storing data (e.g. hard disk drives, solid state drives, flash memory and so on).

### Transaction Data

In the techniques of the present disclosure, transaction data communicated to the data processing apparatus 110 is indicative of properties for future transactions for exchange of physical items between entities. In particular, the transaction data for a future transaction is indicative of at least: identifiers for two entities involved in the future transaction; a type or name for an item to be exchanged; a quantity for the item to be exchanged; and a location and time for the future transaction.

A respective transaction involves exchange of items between two participant entities. For the two participant entities for a given transaction, one of the entities provides items and the other of the entities receives the items. The transaction data for a given transaction specifies two identifiers for identifying the two participating entities. The transaction data may specify an identifier (e.g. ID number and/or name or similar) for a first entity and a similar identifier for a second entity. Different unique identifiers (e.g. ID numbers and/or names) may be assigned to different entities for distinguishing between entities. The transaction data also specifies a type and/or name for a physical item that is to be exchanged using one or more of text and/or item type identifiers. For example, different identifiers (e.g. numbers, letters, alphanumeric codes, or similar) may be assigned to different types of physical items for this purpose. Alternatively or in addition, the transaction data may specify a name for a type of item (i.e. text specifying a name for a type of item). For example, the transaction data may specify an item type such as a type of commodity (e.g. “Soybeans” or “Sunflower Oil”). Alternatively or in addition, the data may specify a name from which a type of the item can be determined. For example, the transaction data may specify a name such as a brand name, from which a type of item can be determined.

The transaction data for a given transaction also specifies a quantity for an item that is to be exchanged. The quantity may be specified using any suitable unit of measurement and it will be appreciated that different units may be applicable for different item types. For example, a specified quantity (amount) may have units corresponding to a number of the physical items, a weight of the physical items (e.g. in kg, tonnes or similar), and/or a volume of the physical items (e.g. in cubic metres or litres or similar). More generally, any suitable unit of measurement may be used and it will be appreciated that different item types may have different units of measurement.

The transaction data for a given transaction also specifies a location and time for the given transaction. The location and time may be defined with varying levels of granularity (resolution). In some examples, the transaction data may specify a location by specifying a name of a city or town, and may specify a time by specifying a week or day. For example, the transaction data may specify a name of a city (and/or a port or depot in that city) and a date such as dd.mm.yy or mm.dd.yy (where d is day, m is month and y is year). In some examples, the transaction data may specify a time with a resolution of hours, minutes or even seconds. In some examples, the transaction data may specify coordinates (e.g. GPS coordinates) for one or more locations.

The transactions relate to future exchanges and in some cases may be referred as open transactions for which quantities can be modified. In some examples, users may upload transactions to the data processing apparatus which may include only an open quantity, or may include both a nominated quantity (one which is fixed) and an open quantity. References herein to quantities for items to be changed refer to an open quantity which can be modified for a future transaction.

Table I schematically represents an example of data fields that may be included in the transaction data. The table below includes a single row for which the entries can be populated to enter the relevant details. It will be appreciated more rows may be included for allowing entering of details for more respective transactions. In some examples the transaction data may comprise a first entity entry (e.g. buyer entity entry), a second entity entry (e.g. seller entity entry), a quantity entry, an item type entry and/or name entry, a location entry, and a time entry. In some examples, a table such as that shown below may be included in a user interface (e.g. web browser interface) for allowing a user to populate the entries and thereby input transaction data for upload to the data processing apparatus 110.

TABLE I

| | | | | | |
|---|---|---|---|---|---|
| First | Second | Quantity | Item | Location | Time |
| Entity | Entity | | type/name | | |

Table I may potentially include multiple rows each corresponding to a different future transaction. A user may thus populate the entries in multiple rows to input transaction data for multiple transactions for upload to the data processing apparatus 110. Different users may thus separately populate such tables to separately input and upload data to the data processing apparatus. Such an arrangement may allow “bulk upload” of transaction data by a given user for a number of transactions. For example, a user may enter text data into such a table to populate one or more rows for thereby entering data for one or more transactions and upload the entered data.

In some examples transaction data may be uploaded by a first entity (e.g. by a user, such as an employee, associated with the first entity) including a given transaction for which the first entity is selling items to (or purchasing items from) a second entity, and other transaction data may also be separately uploaded by the second entity which may relate to that same given transaction. In other words, a same transaction may potentially be uploaded twice by the different participating entities. In some embodiments of the disclosure, the data processing apparatus 110 may perform one or more filtering operations for identifying situations in which a same transaction has been uploaded twice by the different participating entities. This is discussed in more detail later.

More generally, transaction data for future transactions can be specified by clients and communicated to the data processing apparatus 110. The transaction data can thus be received by the data processing apparatus and processed according to the techniques discussed below.

### Transaction Data Processing

In the techniques of the present disclosure, the data processing apparatus 110 is operable to process transaction data and identify, from the transactions included in the transaction data, one or more transaction loops. A transaction loop comprises at least three respective transactions involving at least three respective entities. An example of a transaction loop including three transactions is as follows: a respective transaction in which entity A provides (e.g. sells) items to entity B; a respective transaction in which entity B provides items to entity C; and a respective transaction in which entity C provides items to entity A. In this example, entity A provides items to another entity (entity B), and entity A also receives items from a further entity (entity C) that has received items from the another entity (entity B), and the respective transactions thus form a closed loop or, put differently, a closed chain of transactions starting and ending with a same entity (in this example, entity A). This represents an example of a transaction loop having three transactions involving three respective entities. It will be appreciated that, following the same principles, a transaction loop may comprise three or more respective transactions involving three or more entities. For example, a transaction loop may potentially consist of three transactions, four transactions, five transactions, six transactions, and so on. More generally, transaction loops including N or more respective transactions involving N or more entities can be identified, where N may be a value that is three or more.

Occurrences of transaction loops can be detrimental in terms of efficiency (e.g. energy consumption and greenhouse gas emissions associated with unnecessary transport and storage of items), costs to entities, and operational considerations and logistics (e.g. quality disputes, payment delays, documents and paperwork and so on). In the techniques of the present disclosure, the data processing apparatus 110 is operable to access transaction data and identify, from the transactions included in the transaction data, one or more transaction loops. The data processing apparatus is operable to generate notification data indicative of one or more transaction loops and output the notification data to one or more client devices for thereby notifying one or more identified transaction loops to clients. In this way, users can be notified of one or more transaction loops and agreements can be modified accordingly. In response to identifying a transaction loop, the data processing apparatus may also update transactions (automatically or in response to user confirmation) to account for the identified transaction loop to thereby modify transactions to reduce a quantity of an item that is to be exchanged. This is discussed in more detail later.

Table II provides an example of a three-entity transaction loop including three transactions that may be identified by the data processing apparatus 110. The three transactions are as follows: a transaction for which entity A provides 5000 (i.e. 5 k) items to entity B, a transaction for which entity B provides 3000 items to entity C, and a transaction for which entity C provides 6000 items to entity A.

TABLE II

| | Provider | Receiver | Quantity |
|---|---|---|---|
| Transaction | Entity | Entity | (units) |
| 1 | A | B | 5k |
| 2 | B | C | 3k |
| 3 | C | A | 6k |

In this example, the smallest transaction has a quantity of 3 k units. The transaction loop can be referred to as a “3 k transaction loop”. In this example, the 3 k transaction loop can be identified and allocated. References herein to allocating a transaction loop refer to updating the transactions included in the transaction loop to remove a quantity associated with a smallest transaction in the transaction loop from each of the transactions included in the transaction loop. Hence, in this example the data processing apparatus 110 can be operable to allocate the 3 k transaction loop which results in netting out 3 k from each of the transactions included in the 3 k transaction loop. In particular, the data processing apparatus can update each of transactions 1, 2 and 3 in Table II as follows: update transaction 1 to instead specify exchange of 2 k units (5000-3000=2000) from entity A to entity B, remove transaction 2 entirely, and update transaction 3 to instead specify exchange of 3 k units from C to A (6000−3000=3000). Table III represents an example of updated transactions that that can be generated in this situation. Comparative to Table II, the updated transactions in Table III result in an overall reduction of the quantity of items to be exchanged between the entities.

TABLE III

| Updated | Provider | Receiver | |
|---|---|---|---|
| Transaction | Entity | Entity | Quantity |
| 1 | A | B | 2k |
| 2 | B | C | 0 |
| 3 | C | A | 3k |

Table II and Table III refer to example transactions for forming a three-entity transaction loop and the values are given for explanatory purposes. It will be appreciated that transaction loops involving larger numbers of entities and transactions can potentially be identified.

The data processing apparatus 110 can be operable to receive transaction data from a number of clients and input the transaction data to a loop identifier model for identifying one or more transaction loops for the transaction data.

Transactions included in the transaction data may potentially relate to different types of items. For example, the transaction data may specify a number of transactions relating to two or more different types of items. In some examples, the loop identifier model may include functionality for grouping transactions according to item type so as to obtain a group of transactions corresponding to a same item type so that one or more transaction loops can be identified for the group of transactions corresponding to a same item type. Moreover, the loop identifier model may include functionality for grouping transactions according to item type so as to obtain a plurality of respective groups of transactions each corresponding to a different item type. Hence, the loop identifier model may group transactions according to item type and transaction groups may be analysed separately by the loop identifier model for identifying one or more transaction loops for one or more of the groups.

Alternatively or in addition, the data processing apparatus 110 may analyse transaction data prior to the transaction data being input to the loop identifier model so as to firstly generate a group of transactions corresponding to a same item type. Moreover, prior to the transaction data being input to the loop identifier model, the data processing apparatus may group transactions according to item type so as to obtain a plurality of respective groups of transactions each corresponding to a different item type. Hence, a first group of transactions relating to a first item type may be input to the loop identifier model for identifying one or more transaction loops for the first group of transactions, and a second group of transactions relating to a second item type may be input to the loop identifier model for identifying one or more transaction loops for the second group of transactions. Whilst the above discussion refers to a first group of transactions and a second group of transactions, it will be appreciated that the number of groups can potentially be one, two or a number greater than two.

In some embodiments of the disclosure, a group of transactions may comprise transactions each corresponding to a same item type, a same location, and a time corresponding to a same time range. Moreover, the data processing apparatus 110 may analyse the transaction data and group the transaction data into one or more groups so that each transaction included in a same group corresponds to a same item type, a same location and also a time that corresponds to a same time range. Transactions may specify locations by specifying a name of a city and/or a name of a port (or depot). Transactions may also specify a time by specifying a date (e.g. dd.mm.yyyy). In some examples, each of the transactions included in same group may have a location corresponding to a same city and/or port (or depot) and a time that corresponds to a same day, a same week, or a same month. A time range used for grouping transactions may correspond to any of: one day, two days, one week, one month, two months, or three months or any value in the range 1-100 days.

For example, the transaction data may include a number of transactions corresponding to a given item type with different locations and times, and from this transaction data the data processing apparatus 110 may generate one or more of the following groups: i) a first group of transactions corresponding to a first location and a first time range; ii) a second group of transactions corresponding to the first location and a second time range different from the first time range; iii) a third group of transactions corresponding to a second location and the first time range; and iv) a fourth group of transactions corresponding to the second location and the second time range. This represents an example of grouping transaction data according to item type, transaction location and transaction time, and it will be appreciated that a number of groups may potentially be obtained for different locations and time ranges. Of course, in some examples the uploaded transaction data may include a number of transactions each with a same location and same time range, and the uploaded transaction data may be grouped by the data processing apparatus according to just item type to obtain one or more groups of transaction data. For example, transaction data that can be uploaded to the data processing apparatus 110 may be restricted to at least one of a given location and/or a predetermined time range, and transactions relating to different item types for that location and time range may thus be grouped according to item type to obtain one or more groups of transaction data for input to the loop identifier model. Moreover, transaction data that can be uploaded may be restricted to transactions having times within a same time window (e.g. day, week, month or three-month window). For example, upload of transaction data may be restricted to transactions with times (e.g. future execution dates) falling within a predetermined time duration (e.g. three months) from a current date. Alternatively or in addition, transaction data that can be uploaded may be restricted to transactions having times within two or more predetermined time windows. For example, a first time window may correspond to a given calendar month and a second time window may correspond to a next calendar month.

In some examples, the uploaded transaction data may relate to a potentially large number of different ports (or depots) and accordingly one or more groups may be generated for the transactions associated with that port for one or more time ranges. References herein to a group of transactions refer to transactions each corresponding to a same item type and optionally the transactions may also have been grouped according to transaction location and transaction time.

In some embodiments of the disclosure, a predetermined entity group may be defined in advance which includes entities that each follow a same set of rules (e.g. procedures and standards) and trade in a same type of physical item from one or more common locations. For example, a predetermined entity group may include identifiers for different entities, a location corresponding to a specific port (or one or more specific ports) and an item type. The predetermined entity group can thus group together entities that are known to have characteristics for co-operation and can be used as a predetermined reference for grouping transaction data. The data processing apparatus 110 may analyse the transaction data uploaded by the client devices based on one or more predetermined entity groups and generate at least one group of transactions corresponding to a predetermined entity group. In this way, the data processing apparatus 110 may generate a group of transactions for which the participating entities follow a same set of rules, and the transactions corresponding to a same type of physical item and one or more common location. This can improve processing efficiency and also contribute to improving likelihood of identifying transaction loops acceptable to entities.

More generally, the data processing apparatus 110 may analyse transaction data prior to the transaction data being input to the loop identifier model and identify a plurality of transaction groups, in which each transaction group includes a plurality of transactions each corresponding to a same item type. For ease of explanation the techniques of the present disclosure will generally refer to operations performed with respect to a respective transaction group to identify one or more transaction loops. However, it will be appreciated that the techniques of the present disclosure can be performed for one, two, or more than two transaction groups. In some examples, the data processing apparatus 110 may process different transaction groups in parallel or sequentially for identifying transaction loops.

A group of transactions corresponding to a same item type may comprise any suitable number of respective transactions and, for the purposes of loop identification, should comprise at least three respective transactions involving at least three entities. A number of respective transactions included in a group of transactions corresponding to a same item type is not particularly limited and may be of the order of tens, hundreds or even thousands. Similarly, a number of respective entities associated with the respective transactions included in the group of transactions corresponding to the same item type is not particularly limited and may be of the order of tens, hundreds or even thousands. A number of respective transactions and a number of entities may be the same or different. In the techniques of the present disclosure, at least one transaction loop is identified including some or all of the respective transactions included in a group of transactions corresponding to a same item type. In some examples, at least one transaction loop may be identified which includes a subset of the respective transactions included in a group of transactions corresponding to a same item type such that some of the transactions included in the group may not form part of the transaction loop.

The data processing apparatus 110 is operable to generate notification data indicative of a transaction loop and output the notification data to one or more of the client devices 120. The notification data can be specifically output to client devices associated with the transaction loop. Optionally, the notification data may also be output to other client devices not associated with the transaction loop.

In some embodiments of the disclosure, output of the notification data may be restricted to just the client devices associated with the transaction loop. Generally speaking, the term entity may refer to any of a user, organisation, business or similar. An entity typically has at least one client device associated with that entity. For example, an entity may have a smartphone device, laptop device and/or desktop computing device. A condition of whether an entity is involved in at least one transaction included in a transaction loop can be used for deciding whether to output the notification data to one or more client devices associated with that given entity. In this way, client devices associated with the transaction loop can be notified, and other client devices not associated with the transaction loop may not be notified. Selectively outputting the notification data (or put differently, selective notification) can contribute to improved data security. That is, in some cases entities may upload transaction data that can be kept private (i.e. not accessible to other entities), and sharing of transaction data with other entities may be controlled by outputting notification data for an identified transaction loop. In this way, a portion of an entities uploaded transaction data relating to an identified transaction loop may be shared and other portions of the transaction data that do not relate to an identified transaction loop may remain private. This is discussed in more detail later.

As one possible example, a group of transactions input to the loop identifier may comprise tens or even hundreds of respective transactions, and an identified transaction loop may, for example, comprise 5 respective transactions involving 5 different entities each associated with a different client device. In this case, the data processing apparatus 110 may generate notification data indicative of each of the 5 respective transactions for the transaction loop and output the notification data to the client devices associated with the 5 different entities. In this way, the notification data can be specifically output to the client devices to inform the entities associated with the transaction loop.

The notification data may be indicative of details (i.e. at least identifiers for the entities and the quantities that are to be exchanged and optionally further details such as location and time for the exchange) for each of the transactions included in the transaction loop. For example, the notification data may comprise a table including rows for each of the transactions included in the transaction loop using a format such as that shown in Table I. Using the notification data, entities can thus choose to accept or reject the transaction loop. In the case of a transaction loop being accepted, the data processing apparatus 110 can proceed to allocate the transaction loop and thus update the transactions to thereby achieve reduction in quantities of items to be exchanged and thereby improving efficiency.

More generally, in embodiments of the disclosure the data processing apparatus 110 is configured to: receive, from client devices, transaction data indicative of properties for future transactions for exchange of physical items between entities, wherein the transaction data for a respective transaction is indicative of at least: identifiers for two entities; a type and/or name for an item to be exchanged; a quantity for the item to be exchanged; and a location and time for the transaction; analyse the transaction data and generate a group of transactions corresponding to a same item type; input the group of transactions corresponding to the same item type to a loop identifier model to identify at least one transaction loop comprising at least three respective transactions from the group of transactions; generate notification data indicative of the transaction loop; and output the notification data to one or more of the client devices.

FIG. 3 is a schematic flowchart illustrating a computer implemented method in accordance with embodiments of the disclosure. The method 300 may be performed by the data processing apparatus 110. The method 300 may be implemented using software or specialised hardware. In some embodiments of the disclosure, the method 300 may be implemented by computer software operating on general purpose computing hardware.

The method 300 comprises: receiving (at a step 310), from client devices, transaction data indicative of properties for future transactions for exchange of physical items between entities, wherein the transaction data for a respective transaction is indicative of at least: identifiers for two entities; a type or name for an item to be exchanged; a quantity for the item to be exchanged; and location and time information for the transaction; analysing (at a step 320) the transaction data and generating (at a step 330) a group of transactions corresponding to a same item type; inputting (at a step 340) the group of transactions corresponding to the same item type to a loop identifier model operable to identify at least one transaction loop for the item type comprising at least three respective transactions from the group of transactions; generating (at a step 350) notification data indicative of the transaction loop; and outputting (at a step 360) the notification data to one or more of the client devices.

In some embodiments of the disclosure, the notification data may be output to a given client device in dependence on whether the given client device is associated with an entity having at least one respective transaction included in the transaction loop. Moreover, the notification data can be selectively output to notify one or more entities involved in the transaction loop. In some cases, the notification data may be output only to notify one or more entities involved in the transaction loop. In some cases, the notification data may be output to notify each entity involved in the transaction loop. Alternatively in some examples, one or more entities involved in the transaction loop may not have a registered account with an online service (e.g. online platform), and so notification data may be output to notify each entity involved in the transaction loop and having a registered account and such entities can then notify one or more entities not having a registered account. For example, at least one participating entity for each transaction included in the transaction loop can be notified and, if applicable, a notified participating entity can in turn notify another participating entity for which they have a common transaction. However, in some examples each entity involved in the transaction loop has a registered account with the online service and each of the entities involved in the transaction loop may be notified.

In some embodiments of the disclosure, a loop identifier model may be used that generates a directed graph in dependence on transaction data that is input to the loop identifier model. In particular, the loop identifier model may comprise an algorithm for generating a directed graph in dependence on transaction data. The loop identifier model may be a software model executable by the data processing apparatus 110 for performing transaction loop identification. In some embodiments of the disclosure, the loop identifier model may comprise one or more shortest path algorithms. In some embodiments of the disclosure, Johnson's algorithm may be used. A directed graph may include nodes corresponding to the entities and edges connecting the nodes, in which the edges are directed edges with a direction corresponding to the direction of the exchange of items between the entities. The directed graph may comprise one or more transaction loops (also referred to as loops or circuits) that connect a node with itself via two or more other nodes.

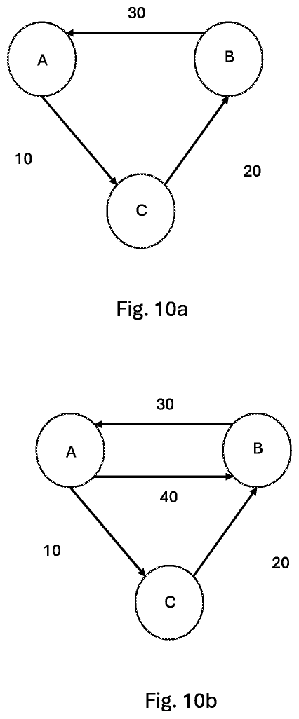

FIG. 10a is a schematic diagram illustrating an example of a directed graph comprising 3 nodes and 3 directed edges (10, 20, 30) representing 3 respective transactions involving the 3 entities A, B and C. FIG. 10a thus provides an example in which the loop identifier model can identify a three-entity transaction loop including three respective transactions. It will be appreciated that the group of transactions provided as input to the loop identifier model may in fact comprise a potentially large number of transactions (e.g. of the order of tens, hundreds or even thousands) and the example directed graph in FIG. 10a may in fact comprise a number of other nodes and directed edges in addition to those shown in FIG. 10a, and the loop identifier model can be operable to identify, among the nodes and directed edges, one or more N-entity transaction loops, wherein N can be a value that is 3 or more.

Hence more generally, in some embodiments of the disclosure the loop identifier model may be operable to generate a directed graph in dependence on a group of transactions and identify one or more loops (also referred to as circuits) included in the directed graph for thereby identifying one or more transaction loops for the group of transactions. In some embodiments of the disclosure, the loop identifier model may comprise a shortest-path algorithm operable to find a shortest path from a given node back to that given node. In particular, in some embodiments of the disclosure, Johnson's algorithm may be used for identifying transaction loops.

In some examples, a directed graph may potentially comprise a two-entity loop (i.e. a loop in which a node has a directed edge connecting to another node, and there is another directed edge in the opposite direction connecting the node and another node). FIG. 10b is a schematic diagram illustrating an example of another directed graph which is the same as that shown in FIG. 10a and which further includes another directed edge 40 representing a transaction involving entities A and B with a direction of exchange that is opposite to that of the directed edge 30. The loop identifier model may be operable to identify the two-entity loop including directed edges 30 and 40, and may also identify the three-entity loop including directed edges 10, 20 and 30. In this situation the two-entity loop and the three entity-loop both include directed edge 30 and are thus mutually exclusive possibilities. The two-entity loop may be given a higher priority than the three-entity loop. Accordingly, the data processing apparatus 110 may thus choose to allocate the two-entity loop instead of the three-entity loop. Allocation of the two-entity loop comprises: obtaining quantities for the two transactions corresponding to the directed edges 30 and 40; and summarising the two transactions as a single transaction with a quantity corresponding to a difference between the quantities. Hence, in the case of FIG. 10b, transactions corresponding to edges 30 and 40 can be summarised as a single edge that connects nodes A and B. For example, the transaction associated with edge 30 may involve exchange of 1200 items from entity B to entity A, and the transaction associated with edge 40 may involve exchange of 500 items from entity A to entity B, and allocation of the two-entity loop may comprise subtracting 500 from 1200 to obtain a remaining quantity of 700 as a new quantity for the transaction associated with edge 30 and removing the transaction associated with edge 40. Accordingly, the two-entity loop may be allocated, and the group of transactions may be updated to account for allocation of the two-entity loop. Following this, the loop identifier model may proceed to identify another loop based on the updated group of transactions. Accordingly, in this case the two-entity loop can be allocated and the updated group of transactions can be input to the loop identifier model to generate a directed graph from which the three-entity transaction loop having three respective transactions involving the entities A, B and C can then be identified.

The above discussion refers to an example in which the loop identifier model may generate a directed graph that may potentially comprise one or more two-entity loops, and two-entity loops are prioritised over loops including three or more entities, and the group of transactions is updated to account for allocation of a two-entity loop. Of course, identification of a two-entity loop is possible without the need for the loop identifier model. In some embodiments of the disclosure, the data processing apparatus 110 may analyse the transaction data (or more specifically a group of transactions corresponding to a same item type) to identify transaction loops involving just two entities prior to inputting data to the loop identifier model. This represents an example of one possible filtering operation that may be performed prior to inputting transaction data to the loop identifier model. More generally, a filtering operation that identifies bi-directional exchange between entities may be performed so as to summarise bi-directional exchanges as a single unidirectional exchange and/or or remove bi-directional exchanges having matching quantities. This can be beneficial in that bi-directional exchanges can be identified and accounted for prior to inputting data to the loop identifier model thereby reducing a size of the data that is input to the loop identifier model and thus improving processing efficiency.

The data processing apparatus 110 may firstly analyse a group of transactions corresponding to a same item type to identify at least one set of two transactions involving bi-directional exchange between a same two entities and perform the above-mentioned allocation to subtract the smallest quantity in one of the two transactions from the biggest quantity and summarise the set of two transactions as a single transaction for which the quantity is equal to the difference between the smallest quantity and the biggest quantity. Accordingly in this case, one or more transaction loops involving just two entities may be identified and allocated, and the group of transactions may be updated to account for the allocation of the one or more transaction loops involving just two entities. In this way, rather than obtaining a directed graph as discussed in FIG. 10b, two-entity loops may firstly be removed from the transaction data and the loop identifier model may be operable to identify loops comprising three or more entities. In some examples, the group of transactions may be provided in a table format with each transaction corresponds to a different row (e.g. Table I as discussed above with multiple rows each corresponding to a different transaction) and the data processing apparatus 110 may be operable to perform a table-scan operation (or similar) to identify a set of two transactions involving bi-directional exchange between a same two entities. This can be particularly beneficial in that, in the group of transactions to be input to the loop identifier model, one or more sets of two transactions involving bi-directional exchange between a same two entities can be identified and allocated and this can reduce the size of data that is input to the loop identifier model and reduce computation time and load.

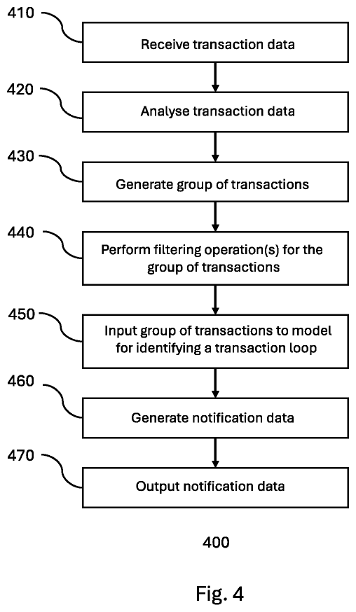

FIG. 4 is a schematic flowchart illustrating a computer implemented method in accordance with some embodiments of the disclosure. In the method 400 the steps 410-430 and 450-470 are the same as those already discussed with respect to FIG. 3, and the method 400 further comprises, at the step 440, performing one or more filtering operations for the group of transactions to remove at least one transaction from the group of transactions prior to the group of transactions being input to the loop identifier model. One or more filtering operations can be performed at the step 440 to reduce a number of transactions included in the group of transactions prior to the group of transactions being input to the loop identifier model. One or more filtering operations may be performed in order to identify bi-directional exchanges and/or identify matching transactions (e.g. duplicate detection techniques) which may arise from transactions being uploaded by each of the participating entities.

In particular, one or more filtering operations can be performed to identify a set of two transactions involving bi-directional exchange between a same two entities, or in other words to identify a two-entity loop. Alternatively or in addition, one or more filtering operations can be performed to identify a pair of matching transactions which may result from two different entities each uploading a same transaction. Alternatively or in addition, one or more filtering operations can be performed to identify a pair of partially matching transactions which may result from two different entities each uploading a same transaction with one or more differences between the information included in the uploaded transactions.

In some embodiments of the disclosure, the step 440 may comprise: analysing the group of transactions to identify a set of two transactions involving bi-directional exchange between a same two entities; summarising the set of two transactions as a single transaction involving unidirectional exchange, or cancelling the set of two transactions when the set of two transactions have matching quantities; and updating the group of transactions to replace the set of two transactions with the single transaction, or removing the set of two transactions when the set of two transactions have matching quantities to thereby obtain an updated group of transactions corresponding to the same item type. Accordingly, the step 450 may thus comprise inputting the updated group of transactions to the loop identifier model. As explained above, performing such processing at the step 440 can contribute to improving processing performance.

Alternatively or in addition, in some embodiments of the disclosure the step 440 may comprise: analysing the group of transactions and identifying at least one pair of matching transactions; and updating the group of transactions corresponding to the same item type in response to identifying matching transactions to remove a respective transaction of the pair of matching transactions or combine the pair of matching transactions into a respective transaction. More generally, in a group of transactions corresponding to a same item type, a pair of transactions that relate to a same future transaction may be identified (this may arise due to a same transaction being uploaded more than once by different entities, or potentially multiple times by a same entity due to user error). In particular, given that a transaction involves exchange of physical items between two entities, there is a possibility that both the providing entity (e.g. seller entity) and the receiving entity (e.g. buyer entity) may have independently uploaded a same transaction and the transaction data may thus include a duplicated transaction. It will be appreciated that there can in fact, potentially, be numerous such duplications for arrangements in which a large number of clients upload transaction data to the data processing apparatus. The presence of such a duplicated transaction can be detrimental for loop identification, and occurrence of such duplicates can be filtered out at the step 440.

Alternatively or in addition, the step 440 may comprise: analysing the group of transactions and identifying transactions that are partially matching; and reporting transactions that are partially matching for user assessment. Partial matches may be identified and a user, such as an admin user and/or a user that has uploaded a transaction having a partial match, may be requested to confirm whether the transaction is a new transaction or relates to an already uploaded transaction. This may involve presenting the two potentially matching transactions to a user for confirmation. In some examples, a partial match may be identified when two entities separately upload transaction data for a same transaction with a discrepancy for one or more properties such as a quantity and/or a delivery date. For example, some entities may upload transactions with a transaction date that differs by one day and such occurrences can be identified as partial matches. Alternatively or in addition, a user may decide to modify a quantity for a transaction resulting a mismatch for the quantities. User assessment may be provided by an admin user for this purpose. Alternatively or in addition, user assessment may be provided by a user that uploaded one of the transactions. This second possibility can potentially give rise to a data security issue for possible arrangements in which uploaded data is at least initially kept private (of course, in some examples uploaded transaction data may be accessible to each of the entities without implementing data privacy techniques). Therefore, in some examples identifying a partial match may require that at least a same two entities are involved and, that the transactions have a same location, and that a transaction date for the transactions is within a predetermined time range (e.g. 1 day, 1 week or 1 month).

FIG. 4 schematically illustrates an example in which the one or more filtering operations are performed at the step 440. In some examples, the one or more filtering operations may instead be performed prior to the step 430 of generating the group of transactions. However, firstly grouping the transactions according to item type and then performing the one or more filtering operations on a group of transactions can yield improvements in processing time and processing efficiency.

### Transaction Loop Identification

Transaction data that is input to the loop identifier model may potentially comprise one, two, or more than two possible transaction loops. It will be appreciated that the number of possible transaction loops can vary according to the properties of the transaction data. The loop identifier model may be operable to identify transaction loops until one or more threshold conditions are met, or the loop identifier model may be operable to identify all possible transaction loops for the transaction data that is input to the loop identifier model.

In some embodiments of the disclosure, the loop identifier model may be run to identify all possible transaction loops included in a group of transactions input to the loop identifier model. In some embodiments of the disclosure, the loop identifier model may be run to identify a number of transaction loops up to a threshold number of transaction loops and/or may be run for a threshold time duration. This is discussed in more detail later. More generally, the loop identifier model may be run and may identify two or more possible transaction loops included in the transaction data input to the loop identifier model.

It is often the case that a given transaction can form part of more than one of the identified transaction loops and that at least some of the identified transaction loops are thus mutually exclusive possibilities. Accordingly, proposing one identified transaction loop may mean that another of the identified transaction loops is no longer a possibility. Hence, in some embodiments of the disclosure the data processing apparatus 110 may be operable to select a respective transaction loop from two or more transaction loops identified by the loop identifier model for a given input, and generate notification data indicative of the selected transaction loop. In this way, from two or more identified transaction loops, a single transaction loop can be notified. As discussed later, one or more properties associated with each of the two or more identified transaction loops may be used for deciding which of the identified transaction loops to select.

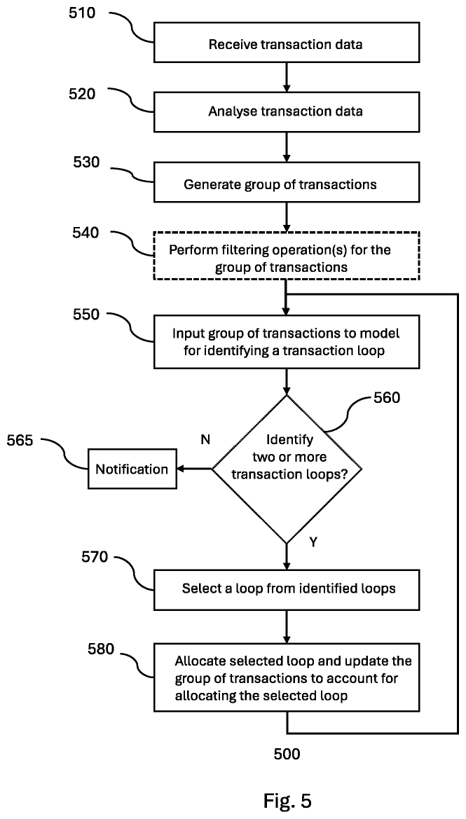

Now turning to FIG. 5, a schematic flowchart is shown illustrating a computer implemented method in accordance with some embodiments of the disclosure. The method 500 comprises: receiving (at a step 510), from client devices, transaction data indicative of properties for future transactions for exchange of physical items between entities; analysing (at a step 520) the transaction data and generating (at a step 530) a group of transactions corresponding to a same item type; performing (at a step 540) one or more filtering operations for the group of transactions to remove at least one transaction from the group of transactions; inputting (at a step 550) the group of transactions corresponding to the same item type to a loop identifier model operable to identify at least one transaction loop for the item type comprising at least three respective transactions from the group of transactions; identifying (at a step 560) two or more transaction loops included in the group of transactions; in response to identifying two or more transaction loops, selecting (at a step 570) a respective transaction loop from the two or more identified transaction loops; and allocating (at a step 580) the respective transaction loop and updating the group of transactions to account for allocating the respective transaction loop.

The steps 510, 520, 530, 540 and 550 are the same as the steps discussed previously with respect to FIGS. 3 and 4. The step 540 is optional, as indicated by the dashed box in FIG. 5. At the step 560 the loop identifier model is operable to identify transaction loops included in the group of transactions. The step 560 may be performed to identify all possible transaction loops for the group of transactions or may be performed according to one or more control parameters for the loop identifier model specifying one or more thresholds (such as a threshold number of transaction loops and/or a threshold run time). If fewer than two transaction loops are identified at the step 560, then the method proceeds to the step 565 to generate and output one or more notifications for one or more transaction loops. When applicable, the notification at the step 565 may potentially indicate that no transaction loops were identified at the step 560 or that a single transaction loop was identified at the step 560. If two or more transaction loops are identified at the step 560, then the method proceeds to the step 570. At the step 570, a respective transaction loop is selected from the two or more identified transaction loops. In particular, one or more properties associated with each of the two or more identified transaction loops may be used for deciding which of the identified transaction loops to select. This is discussed in more detail later.

At the step 580, the selected transaction loop is allocated and the group of transactions is updated to account for allocating the selected transaction loop to thereby obtain an updated group of transactions. Allocation of the selected transaction loop is achieved by removing, from each of the respective transactions, a quantity associated with a smallest transaction in the selected transaction loop. This effectively results in reducing the quantities for the transactions included in the selected transaction loop and removing the smallest transaction.

After the step 580, the method returns to the step 550 (as shown by the feedback loop in FIG. 5) and proceeds to input the updated group of transactions to the loop identifier model so as to identify transaction loops for the transactions included in the updated group of transactions. The method steps 560, 570 and 580 can thus be performed again based on the updated group of transactions. The method steps 550, 560, 570 and 580 can thus be performed in a looping manner with each loop being performed for a next updated group of transactions that accounts for the transaction loop that has been allocated in the previous loop. Accordingly, the method steps 550, 560, 570 and 580 can be performed to select and allocate a first transaction loop, and the method steps 550, 560, 570 and 580 can be subsequently performed again to select and allocate a second transaction loop and so on. In this way, a set of transaction loops can be obtained that are not mutually exclusive and the set of transaction loops can eventually be notified together.

Accordingly, with each successive feedback loop in the method 500, the transaction data input to the loop identifier model at the step 550 is such that there is a lower likelihood of identifying transaction loops. At the step 560, when fewer than two transaction loops are identified (i.e. no identified transaction loop or a single transaction loop), the method proceeds to the step 565. At this point, a set of transaction loops that have been selected and allocated up to that point can be notified.

FIG. 5 represents an example in which a selected transaction loop is automatically allocated and the group of transactions is automatically updated to account for the allocation to proceed with selecting a next transaction loop that is not mutually exclusive. Accordingly, the method 500 can be automatically performed to obtain a group of transaction loops that are not mutually exclusive for being notified.

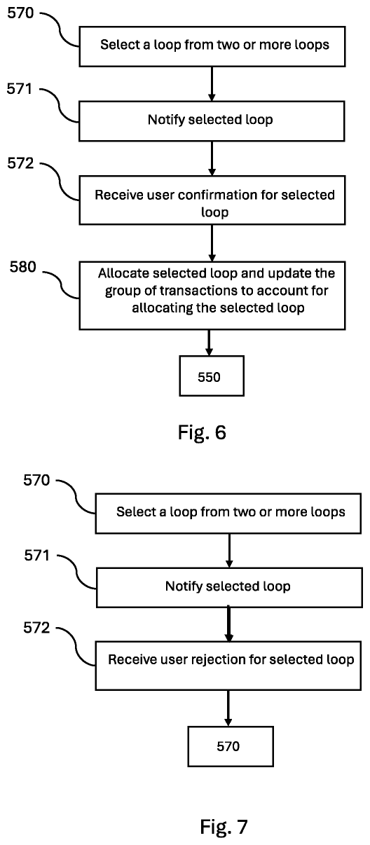

In some embodiments of the disclosure, the method 500 may include a step of notifying one or more entities/clients and requesting user confirmation prior to allocating a selected transaction loop. In particular, the method 500 may comprise further steps between the steps 570 and 580 for notifying entities of a selected transaction loop and obtaining user confirmation. FIG. 6 schematically illustrates an example in which the method 500 further comprises the steps 571 and 572. The method 500 may further comprise: notifying (at a step 571) the selected transaction loop to one or more entities (by communicating notifications to client devices associated with entities); and receiving (at a step 572) user confirmation for the selected transaction loop. As shown in FIG. 6, the method proceeds to allocate the selected transaction loop responsive to receiving the user confirmation. For example, in response to selecting a transaction loop involving entities A, B and C (as discussed previously in relation to the example in Table I), each of the entities A, B and C may be requested to confirm the transaction loop before the method proceeds to allocate the transaction loop. Notifications may be sent to client devices associated with each of the entities to request confirmation of the transaction loop. In some examples, there may be a pre-set time duration for receiving confirmation and if the pre-set time duration expires without confirmation having been received from each of the entities, then the method may return back to the step 570 to select another of the two or more transaction loops and request confirmation in respect of another transaction loop.

FIG. 7 schematically illustrates an example in which at the step 572 a user (i.e. a user associated with one of the entities) rejects the selected transaction loop. For example, whilst entity A and B may confirm the selected transaction loop, entity C may choose to reject the selected transaction loop. In response to receiving user rejection at the step 572, the method may return back to the step 570 to select another of the two or more transaction loops and request confirmation in respect of another transaction loop (this is schematically shown in FIG. 7). Alternatively, in response to receiving user rejection at the step 572, the method 500 may end in respect of the group of transaction data. As mentioned previously, transaction data accessible to the data processing apparatus 110 may be processed periodically. The method 500 may thus be performed periodically, and transaction data accessible to the data processing apparatus 110 may vary over time as entities add new transactions and/or modify transactions. Knowledge of a previously rejected transaction loop may be used so as to inhibit (e.g. prevent) a previously rejected transaction loop from being selected and notified a second time.

The above discussion with respect to FIGS. 6 and 7 refers to requesting each entity involved in the selected transaction loop to confirm acceptance of the selected transaction loop. For example, emails (or other similar notifications) may be communicated to each of the involved entities including the details of the selected transaction loop and also a selectable option to confirm or reject the transaction loop. Alternatively or in addition, other similar notifications such as SMS messages and notifications associated with mobile software applications (e.g. push notifications) may be communicated to client devices. A user may select a user interface element to confirm their acceptance of the transaction loop. In response to a user selecting to confirm the transaction loop, a communication indicative of the confirmation can be communicated to the data processing apparatus 100.

The above discussion with respect to FIGS. 6 and 7 refers to an example in which each of the entities involved in the selected transaction loop is required to provide confirmation. In some examples, one or more entities involved in the selected transaction loop may not be required to provide confirmation. For example, the data processing apparatus 110 may notify each entity involves in the selected transaction loop and, in response to receiving confirmation from at least a threshold number of the entities, the selected transaction loop may be allocated. For example, the selected transaction loop may be allocated when at least Z % (e.g. Z=10, 20, 30, 40, 50, 60, 70, 80, 90, or 100%) of the involved entities confirm the selected transaction loop.

In some examples, one or more entities involved in a selected transaction loop may not have a registered account with the online service and/or contact details may not be known for one or more of the entities involved in the selected transaction loop. More generally, one or more entities involved in a selected transaction loop may not be notified. In this situation, only entities involved in the selected transaction loop and having a registered account may be notified and required to provide confirmation. In response to receiving confirmation from each of the entities having a registered account, the data processing apparatus may proceed to allocate the selected transaction loop. In this case, one or more involved entities having a registered account may contact one or more other involved entities not having a registered account so as to notify those entities of the selected transaction loop. For example, in the case of Table II, entities A and C may have uploaded the transactions and entity B may not have a registered account. In this situation, entities A and C may be requested to confirm the selected transaction loop involving entities A. B and C and the method (as discussed in FIGS. 6 and 7) may proceed conditional on receiving confirmation from just entities A and C (i.e. without needing confirmation from entity B). In this situation, entities A and C may optionally be notified that entity B has not been requested to confirm the transaction loop so that one or both of the entities A and C can proceed to confirm the transaction loop with entity B. Of course, this is one possible situation and in some cases each entity involved in the selected transaction loop may have a registered account and may be required to provide confirmation.

### Transaction Loop Selection

It is often the case that at least some (or potentially each) of the transaction loops identified for a given input can be mutually exclusive possibilities due to a same transaction being included in different identified transaction loops. Accordingly, even though two or more transaction loops may be identified by the loop identifier model for a given input, the data processing apparatus 110 can be operable to automatically select a respective transaction loop therefrom. The data processing apparatus 110 can be operable to automatically select respective transaction loop from two or more transaction loops identified by the loop identifier model and notify the selected transaction loop to one or more clients. In particular, one or more properties associated with identified transaction loops may be used by the data processing apparatus for selecting a respective transaction loop. One or more properties used for selection may comprise one or more of: a quantity associated with a respective transaction having a smallest quantity in each of the transaction loops; a total number of entities associated with a respective transaction loop; and/or a total number of entities associated with a respective transaction loop that do not have a registered account with an online service provided by the data processing apparatus.

Quantities associated with identified transaction loops may be used for selecting a respective transaction loop from the identified transaction loops. In particular, a quantity (e.g. number of items) associated with a smallest transaction in each identified transaction loop can be determined so as to select a transaction loop that is capable of allocating a greatest quantity. For example, in the case of the loop identifier model identifying a first transaction loop for which the smallest transaction exchanges X items and also identifying a second transaction loop for which the smallest transaction exchanges Y items (where Y is a value less than X), the first transaction loop can be selected. This is because the first transaction loop can be allocated to remove X items (or in other words to net-out X items) from each transaction included in the first transaction loop, and selecting the first transaction loop results in a greater reduction in items to be exchanged for the transactions compared to selecting the second transaction loop which instead can be allocated to remove Y items from each of the transactions included in the second transaction loop. Moreover, for a given transaction loop, a maximum quantity that can be allocated is limited to the quantity for the smallest transaction in that given transaction loop.

Hence more generally, in some embodiments of the disclosure the data processing apparatus 110 may select a respective transaction loop from the two or more transaction loops in dependence on one or more properties for the two or more transaction loops, wherein the one or more properties may comprise at least a quantity associated with a respective transaction having a smallest quantity in each transaction loop. In particular, the data processing apparatus 110 may: determine a quantity associated with a respective transaction having a smallest quantity in each of the two or more transaction loops; and select, from the two or more transaction loops, the respective transaction loop for which the respective transaction having the smallest quantity is greatest.

The above discussion refers to using at least a quantity associated with a respective transaction having a smallest quantity in each transaction loop as a property for selection of a transaction loop. In some examples, both a quantity associated with a respective transaction having a smallest quantity in each transaction loop and a total number of transactions included in each transaction loop may be used to calculate a net amount of items that can be netted out by allocating each transaction loop (i.e. multiplying the smallest quantity by the number of transactions), and a transaction loop having the largest net amount of items that can be netted out may be selected.

As well as considering a quantity of items that can be allocated, it can be beneficial to consider one or more other properties that may impact a likelihood of a transaction loop being accepted by the involved entities. For a transaction loop involving larger numbers of entities there is a higher likelihood of at least one of the entities rejecting the transaction loop or later deciding to cancel the transaction loop. For example, a transaction loop involving ten entities has a higher likelihood of rejection and/or cancellation than a transaction loop involving three entities. In some embodiments of the disclosure, the data processing apparatus 110 may calculate a score for each of two or more transaction loops in dependence on: a smallest exchanged quantity for each transaction loop; and a total number of entities associated with that transaction loop. The data processing apparatus may rank each of the two or more transaction loops according to their calculated scores and select a highest ranked transaction loop (score calculation may be performed as part of the step 570 discussed in relations to FIGS. 5, 6 and 7).

In some cases, at least some of the transactions uploaded to the data processing apparatus 110 may involve entities that do not have a registered account with an online service provided by the data processing apparatus. For example, referring to Table I, in some examples, each of the entities A, B and C may have a registered account for the service provided by the data processing apparatus. Accordingly, in response to identifying the three-entity transaction loop involving the three entities A, B and C, each of these entities can be notified of the three-entity transaction loop. In some cases, the entities may be asked to confirm their acceptance of the transaction loop and once confirmation is received the transaction loop may be allocated. In some examples, at least some of the transactions included in an identified transaction loop may involve entities that do not have a registered account and/or are not capable of being notified. Transaction loops with increasing numbers of entities that do not have a registered account with the online service increase a likelihood of delays and/or cancellation of the transaction loop. Generally, a transaction loop with a higher number of entities that do not have a registered account with the online service is less favourable. In some embodiments of the disclosure, the data processing apparatus 110 may calculate a score for each of two or more transaction loops in dependence on: smallest exchanged quantity for each transaction loop; a total number of entities associated with that transaction loop; and a total number of entities associated with the respective transaction loop that do not have a registered account with an online service provided by the data processing apparatus. Selection of a transaction loop from two or more transaction loops may thus be performed on the basis of the score calculated for each of the two or more transaction loops.

Hence, in some examples the loop identifier model may potentially identify two or more transaction loops for a given input, and the data processing apparatus 110 may calculate a score for each of the two or more transaction loops in dependence on one or more properties for the two or more transaction loops, and select a respective transaction loop in dependence on the calculated scores.

More generally, properties used for selection of a respective transaction loop from two or more transaction loops may comprise any of the following: i) a quantity associated with a respective transaction having a smallest quantity in each of the transaction loops; ii) a total number of entities associated with a respective transaction loop; iii) a total number of entities associated with a respective transaction loop that do not have a registered account with an online service provided by the data processing apparatus; and iv) any combination of i), ii) and iii).

In some examples, in addition to the properties listed above, one or more thresholds may be defined for selection of a respective transaction loop from two or more transaction loops. Selection may be performed based on evaluating (e.g. comparing) any of the properties listed above with one or more corresponding thresholds (e.g. predefined threshold values for those properties). In some examples, one or more thresholds may define one or more suitable ranges for one or more of the properties listed above so that a selected transaction loop has one or more properties within one or more defined ranges.

A first threshold may define a threshold number of entities associated with a respective transaction loop. The first threshold may define at least one of a minimum number of entities associated with a transaction loop and/or a maximum number of entities associated with a transaction loop. The first threshold may define a minimum number of entities associated with a transaction loop such that the selected transaction loop is required to include a number of entities that is greater than or equal to the minimum number of entities. Alternatively or in addition, the first threshold may define a maximum number of entities associated with a transaction loop such that the selected transaction loop is required to include a number of entities that is not more than the maximum number of entities.

For example, the first threshold may define lower and upper values for the number of entities associated with a transaction loop and may, for example, define a lower value in the range 3-10 and an upper value in the range 5-14. In some examples, the first threshold may define a range of 3-14 for the number of entities, or more specifically a range of 5-7 for the number of entities. In this way, selection of a respective transaction loop can be performed in dependence on the first threshold so that the selected transaction loop has a total number of entities in the range defined by the first threshold. Generally speaking, the aim is to increase a quantity that can be netted out, and transaction loops with increasing numbers of entities are considered desirable for this purpose. However, transaction loops with increasing numbers of entities have an increasing likelihood of rejection and/or cancellation by one or more entities. Accordingly, the first threshold may be set to achieve a balance between increasing a quantity that can be allocated and reducing a likelihood of rejection and/or cancellation for the selected transaction loop. For example, a transaction loop with a number of entities in the range 5-7 may achieve a suitable balance for these competing factors.

A second threshold may define a threshold number of registered entities (i.e. entities having a registered account with the online service) and/or a threshold number of non-registered entities (i.e. entities not having a registered account with the online service). The second threshold may define a maximum number of non-registered entities for a transaction loop. Alternatively or in addition, the second threshold may define a minimum number of registered entities for a transaction loop. In this way, the second threshold can be used to ensure that a selected transaction loop has a number of registered entities that is greater than or equal to the threshold minimum number of registered entities and/or has a number of non-registered entities that is not more than the threshold maximum number of non-registered entities.

Alternatively or in addition, the second threshold may define a ratio of a number of registered entities to a number of non-registered entities. For example, a ratio of X:Y (where X corresponds to number of registered entities and Y corresponds to number of non-registered entities) may be defined where X is a value that is greater than or equal to Y. For example, a ratio of X:1 may be defined where X may be any value in the range 1 to 10. The ratio may be used as a lower limit so that a selected transaction loop is required to have a ratio of registered entities to non-registered entities that is at least the same as or greater than the ratio defined by the second threshold. For example, the second threshold may define a ratio of 1.5:1 so that the selected transaction loop is required to have a ratio of registered entities to non-registered entities of at least 1.5:1 (e.g. in this case a transaction loop with more registered entities than non-registered entities can be selected and selection of another transaction loop with, for example, equal numbers of registered entities and non-registered entities can be inhibited). Generally speaking, transaction loops with increasing numbers of non-registered entities have a higher likelihood of delays, rejection and/or cancellation. Accordingly, the second threshold may be set to impose a lower limit on a ratio of registered entities to non-registered entities. In a similar manner, the second threshold may, alternatively or additionally, define a ratio of a number of non-registered entities to a number of registered entities (e.g. Y: X) and the threshold may be set to impose an upper limit on a ratio of non-registered entities to registered entities.

In some examples, the data processing apparatus 110 may use a historical loop prioritisation technique. As explained above, in some examples transaction data may be grouped to obtain a first group of transactions corresponding to a same item type for a first time range (e.g. first time window) and a second group of transactions also corresponding to that same item type for a second time range (e.g. second time window). For example, entities may upload transaction data including transactions for two or more different months, and the transaction data may be grouped to obtain two or more respective groups for the two or more different months. The data processing apparatus 110 can be operable to input the first group of transactions corresponding for the first time range to the loop identifier model and a respective transaction loop can be identified and selected according to any of the techniques discussed herein. In some examples, a transaction loop selected for the first group of transactions corresponding for the first time range may be used so that the data processing apparatus 110 prioritises finding a transaction loop having the same characteristics (i.e. same entities and same or similar transactions) for the second group of transactions. Put differently, the data processing apparatus may use a historical loop prioritisation technique which allows information for a selected transaction loop to be used for identifying and selecting further transaction loops for other time windows.

For example, entities may upload transaction data including transactions for a first month (as an example of a time window), and may also upload transaction data including similar (or potentially identical) transactions for one or more subsequent months. Transactions may be similar in that they involve the same two entities but with differing quantities for the different time windows. In this case, there is the possibility for a transaction loop with the same characteristics (same entities and same or similar transactions) to be identified and selected across two or more different time windows. For example, a transaction loop such as A-B-C-A (where A, B and C represent different entities) may be identified for one time window and this may be used for identifying a transaction loop with the same entities for another time window.

In particular, for a first month, a given transaction loop may be identified and selected (e.g. according to the techniques discussed in relation to FIGS. 5-7). Transaction loop information indicative of characteristics for the given transaction loop identified and selected for the first month may be used to prioritise selection of another transaction loop with the same characteristics for the second month. In this way a transaction loop for the second month may potentially be identified without using the loop identifier model to process the second month's transaction data, or the transaction loop information may be used (e.g. at the step 570) for selecting a transaction loop from two or more transaction loops that have been identified by the loop identifier model for the second month. More generally, transaction loop information for one month may be applied to identify and select one or more other transaction loops for one or more subsequent months, potentially without requiring use of the loop identifier model for one or more of the subsequent months.

Hence more generally, the data processing apparatus 110 may be operable to use characteristics for an identified and selected transaction loop to identify and select one or more further transaction loops across one or more subsequent time windows.

### Control Parameters

In some embodiments of the disclosure, the loop identifier model may be run to identify all possible transaction loops included in a group of transactions input to the loop identifier model.

Identifying all possible transaction loops can be expensive both computationally and in terms of computation time. Moreover, given that identified loops can be mutually exclusive, once a number of loops have been identified it can often be computationally wasteful to identify further loops. It will be appreciated that with increasing numbers of transactions (corresponding to increasing numbers of nodes and directed edges in a directed graph) the number of possible transaction loops can increase significantly. Identifying large numbers of transaction loops in a directed graph can be a computationally expensive task with potentially little or no benefit. Therefore, in some embodiments of the disclosure a number of transaction loops identifiable by the loop identifier model for a set of input transaction data is limited to a threshold number of transaction loops, and/or a running time for the loop identifier model to identify transaction loops for a set of input transaction data is limited to a threshold time duration. One or more control parameters may define one or more of a threshold number of transaction loops and/or a threshold time duration so as to limit a number of transaction loops that can be identified for a given input and/or limit an amount of time for identifying transaction loops. The one or more parameters may have predetermined values (programmed in advance by a developer). The one or more parameters may be updatable in response to user inputs. The loop identifier model may be run to identify transaction loops for a given input and, in response to any of the threshold number of transaction loops and/or the threshold time duration being met, identification of further transaction loops may stop. Therefore, in the case where a number of found loops is at least equal to a threshold number of loops, the loop identifier model can be stopped early (i.e. stopped without proceeding to identify all possible loops). Hence, the loop identifier model may comprise one or more such control parameters for improving processing efficiency for loop identification.

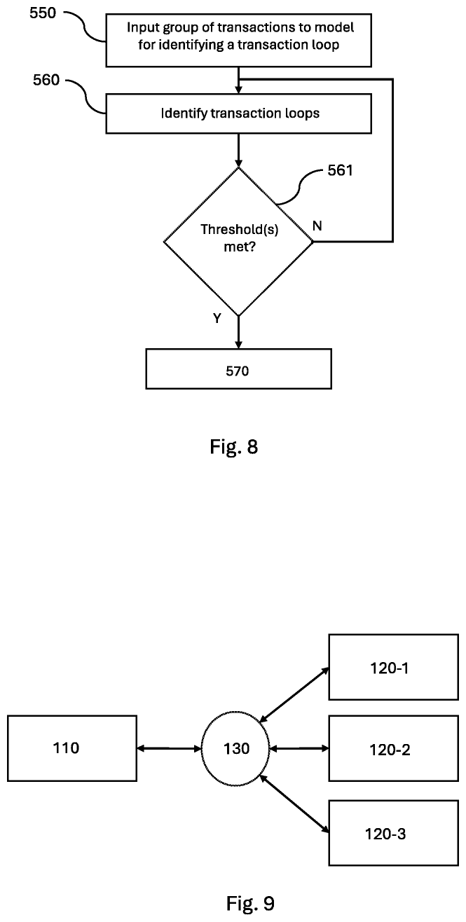

Referring again to FIG. 5 the method 500 may comprise further steps between the steps 560 and 570. In particular, the method 500 may comprise steps for limiting a number of transaction loops and/or a running time for the loop identifier model according to one or more thresholds. FIG. 8 schematically illustrates method steps which may be performed between the steps 560 and 570. In FIG. 8, the steps 550 and 560 are the same as those discussed previously with respect to FIG. 5. The method may also comprise evaluating (at a step 561) whether one or more threshold conditions have been met. If so, the method may proceed to the step 570 (which is the same as discussed with respect to FIG. 5) to proceed to select a transaction loop. If the one or more threshold conditions have not been met, the method continues with identifying transaction loops. Evaluation of whether one or more threshold conditions have been met may be performed periodically and/or in response to identification of each transaction loop so as to allow a decision as to whether to continue with loop identification for the given input or proceed with selection of a loop.

In some embodiments of the disclosure, the loop identifier may use Johnson's algorithm to find loops in a directed graph. In some embodiments of the disclosure, a modification of Johnson's algorithm may be used for loop identification. In particular, a control parameter may be provided which defines a threshold number of loops each originating from a given node. In response to identifying a threshold number of loops each originating from a same given node, processing to identify further loops originating from that same given node can be stopped. In other words, a number of loops that originate from a respective node can be limited to no more than the threshold number.

For example, a number of identified loops that originate from a given node may be tracked (e.g. using an incremental counter) and when the number of identified loops originating from that given node is equal to the threshold number, processing for identifying loops originating from that given node may be stopped. In some examples, a control parameter may be provided which defines a threshold of 1000 loops for each node. Accordingly, Johnson's algorithm may be run with an upper bound on a number of loops that can be identified being set to 1000 possible loops originating from each node. Therefore, in cases where there are more than 1000 loops originating from a respective node, the control parameter can shorten a processing time. In other cases, where the transaction data is such that there are not more than 1000 loops originating from a respective node, the loop identifier model can identify all possible transaction loops.

The above discussion refers to using a threshold of 1000 loops for each node. Different values may be used for this and the value may be updateable by a user. In some examples, a value used for the threshold number of loops per node may be set to a value in the range 2-1000.

### Data Privacy

FIG. 9 schematically illustrates an example of a system comprising the data processing apparatus 110 and three client devices 120-1, 120-2 and 120-3. The client devices may each be associated with a different entity for allowing uploading of transaction data including transactions involving that entity and also for receiving notification data from the data processing apparatus.

FIG. 9 represents an example including three client devices. It will be appreciated that the number of client devices is not particularly limited. Client device 120-1 may be associated with a first entity (entity A). Client device 120-2 may be associated with a second entity (entity B). And client device 120-3 may be associated with a third entity (entity C).

In some examples, a given entity may be able to access and view transaction data that has been uploaded by that given entity and may also have access to transaction data that has been uploaded by one or more other entities. For example, a user interface associated with a given entity may display transaction data that has been uploaded by that entity and may also display transaction data that has been uploaded by other entities. Accordingly, entities may be able to upload transaction data and freely view transaction data that has been uploaded by other entities.

However, maintaining privacy of uploaded transaction data and enabling selective sharing of portions of uploaded transaction data only with other entities in a same transaction loop may be desirable for some or all entities, and may provide entities with reassurance that potentially sensitive information is secured and only shared to the extent needed for transaction loop acceptance, thus increasing likelihood of service uptake. In some examples a given entity may be able to access and view transaction data that has been uploaded by that given entity and may not be able to access and view transaction data that has been uploaded by other entities. For example, entity A may upload transaction data and be able to access the uploaded transaction data to review and potentially update and/or modify the data. Similarly, entity B may upload transaction data and be able to access the uploaded transaction data to review and potentially update and/or modify the data. A user interface may be displayed for allowing clients to access and view their uploaded transaction data. For example, a dashboard or other similar graphical user interface may be used to display an entity's uploaded transaction data. Web browser techniques and/or email techniques may be used for displaying such graphical user interfaces.

More generally, the data processing apparatus 110 may be operable to: receive first transaction data uploaded from client device 120-1 associated with the first entity, store the first transaction data to the storage circuitry 220, and generate a first user interface accessible to the first client device 120-1 for displaying the first transaction data; receive second transaction data uploaded from client device 120-2 associated with the second entity, store the second transaction data to the storage circuitry 220, and generate a second user interface accessible to the second client device 120-2 for displaying the second transaction data; and receive third transaction data uploaded from client device 120-3 associated with the third entity, store the third transaction data to the storage circuitry 220, and generate a third user interface accessible to the third client device 120-3 for displaying the third transaction data.

In some examples, a given entity may be able to access and view transaction data that has been uploaded by that given entity and may not be able to (at least initially) access and view transaction data that has been uploaded by other entities. In this way, the techniques of the present disclosure can allow information for uploaded transactions to be kept private (i.e. not shared with other entities) thus improving data security. In response to a transaction loop that includes at least one transaction involving a given entity, notification data indicative of the transaction loop can be generated and output to that given entity. The notification data includes details for each transaction included in the transaction loop. In this way, information for other transactions in the transaction loop not involving the given entity can be included in the notification data and thus made available to the given entity. Moreover, information can thus be shared between entities to the extent needed for establishing transaction loops. Therefore, the techniques of the present disclosure allow privacy of uploaded transaction data and sharing of data between entities to the extent needed for allowing entities to confirm transaction loops.

In some examples, a given entity may have access to both transaction data that has been uploaded by that entity and also one or more transactions uploaded by one or more other entities for which the given entity is a transaction participant. Rather than just having access to their own uploaded data, entities may also be able to access transactions uploaded by other entities provided that they are a participating entity for those transactions. For example, uploaded transactions may specify identifiers for entities (e.g. ID numbers) which may be used to link a transaction to a given entity even though the transaction has been uploaded by a different entity.

In some embodiments of the disclosure, in response to an identified transaction loop comprising at least one transaction involving the first entity and at least one transaction involving the second entity, the data processing apparatus 110 may allow access via the first user interface associated with the first entity and the second user interface associated with the second entity to the notification data indicative of the identified transaction loop. The notification data is indicative of details for the transactions included in the transaction loop. Provided that the first entity has at least one transaction included in the transaction loop, the notification data for the transaction loop can be made accessible to the first entity. Similarly, provided that the second entity has at least one transaction included in the transaction loop, the notification data for the transaction loop can be made accessible to the second entity. More generally, the notification data can potentially be made accessible to each entity associated with the transaction loop via their user interface. In this way, uploaded transaction data can potentially be kept private from other entities and targeted sharing transaction data relevant for a transaction loop can be enabled.

In some embodiments of the disclosure, the notification data may comprise a selectable user interface element for confirming an identified transaction loop, and the data processing apparatus 110 may generate confirmation data for the identified transaction loop in response to receiving confirmation from each entity involved in the identified transaction loop having a registered account with the online service.

In some embodiments of the disclosure, in response to an identified transaction loop comprising at least the first entity and the second entity, the data processing apparatus 110 may generate an online chat for enabling message exchange between at least the first entity and the second entity. An online chat may be generated for enabling message exchange between all or some of the entities associated with an identified loop. The online chat may allow online messaging functionality for allowing fast and efficient coordination between relevant entities for confirming, and potentially discussing, a transaction loop.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Although certain example embodiments of the invention have been described, the scope of the appended claims is not intended to be limited solely to these embodiments. The claims are to be construed literally, purposively, and/or to encompass equivalents.

When used in this specification and claims, the terms “comprises” and “comprising” and variations thereof mean that the specified features, steps or integers are included. The terms are not to be interpreted to exclude the presence of other features, steps or components.

It will be appreciated that example embodiments can be implemented by computer software operating on a general purpose a computing system. In these examples, computer software, which when executed by a computer, causes the computer to carry out any of the methods discussed above is considered as an embodiment of the present disclosure. Similarly, embodiments of the disclosure are provided by a non-transitory, machine-readable storage medium which stores such computer software.

It will also be apparent that numerous modifications and variations of the present disclosure are possible in light of the above teachings. It is therefore to be understood that within the scope of the appended claims, the disclosure may be practised otherwise than as specifically described herein.

What is claimed is:

1. A data processing apparatus comprising processing circuitry to:
receive, from client devices, transaction data indicative of properties for future transactions for exchange of physical items between entities, wherein the transaction data for a respective transaction is indicative of at least: identifiers for two entities; a type and/or name for an item to be exchanged; a quantity for the item to be exchanged; and a location and time for the transaction;
analyse the transaction data and generate a group of transactions corresponding to a same item type;
input the group of transactions corresponding to the same item type to a loop identifier model to identify a transaction loop comprising at least three respective transactions from the group of transactions;
generate notification data indicative of the transaction loop; and
output the notification data to one or more of the client devices.

2. The data processing apparatus according to claim 1, wherein the data processing apparatus is configured to output the notification data to a given client device in dependence on whether the given client device is associated with an entity having at least one respective transaction included in the transaction loop.

3. The data processing apparatus according to claim 1, wherein the data processing apparatus is configured to perform one or more filtering operations for the group of transactions to remove at least one transaction from the group of transactions prior to the group of transactions being input to the loop identifier model.

4. The data processing apparatus according to claim 1, wherein the data processing apparatus is configured to:
analyse the group of transactions to identify a set of two transactions involving bi-directional exchange between a same two entities;
summarise the set of two transactions as a single transaction involving unidirectional exchange, or cancel the set of two transactions when the set of two transactions have matching quantities;
update the group of transactions to replace the set of two transactions with the single transaction, or remove the set of two transactions when the set of two transactions have matching quantities, to thereby obtain an updated group of transactions corresponding to the same item type; and
input the updated group of transactions to the loop identifier model.

5. The data processing apparatus according to claim 1, wherein the data processing apparatus is configured to:
analyse the group of transactions and identify at least one pair of matching transactions; and
update the group of transactions corresponding to the same item type in response to identifying matching transactions to remove a respective transaction of the pair of matching transactions or combine the pair of matching transactions into a respective transaction.

6. The data processing apparatus according to claim 1, wherein the data processing apparatus is configured to:
analyse the group of transactions and identify transactions that are partially matching; and
report transactions that are partially matching for user assessment.

7. The data processing apparatus according to claim 1, wherein the loop identifier model is operable to identify two or more transaction loops each comprising at least three respective transactions from the group of transactions corresponding to the same item type.

8. The data processing apparatus according to claim 7, wherein the data processing apparatus is configured to select a respective transaction loop from the two or more transaction loops and generate notification data indicative of the respective transaction loop.

9. The data processing apparatus according to claim 8, wherein the data processing apparatus is configured to select a respective transaction loop from the two or more transaction loops in dependence on one or more properties for the two or more transaction loops, wherein the one or more properties comprise at least a quantity associated with a respective transaction having a smallest quantity in each of the transaction loops.

10. The data processing apparatus according to claim 9, wherein the data processing apparatus is configured to:
determine a quantity associated with a respective transaction having a smallest quantity in each of the two or more transaction loops; and
select, from the two or more transaction loops, the respective transaction loop for which the respective transaction having the smallest quantity is greatest.

11. The data processing apparatus according to claim 9, wherein the one or more properties further comprise at least one of:
a total number of entities associated with a respective transaction loop; and
a total number of entities associated with the respective transaction loop that do not have a registered account with an online service provided by the data processing apparatus.

12. The data processing apparatus according to claim 1, wherein the identified transaction loop is selected from two or more transaction loops identified by the loop identifier model based on one or more user inputs or based on automatic selection by the data processing apparatus, and wherein the data processing apparatus is configured to:
update the group of transactions corresponding to the same item type in dependence on the identified transaction loop to obtain an updated group of transactions;
input the updated group of transactions to the loop identifier model to identify a next transaction loop comprising at least three respective transactions from the updated group of transactions; and
generate notification data indicative of the next transaction loop, wherein the identified transaction loop and the next transaction loop are not mutually exclusive.

13. The data processing apparatus according to claim 12, wherein the data processing apparatus is configured to:
determine a quantity associated with a respective transaction having a smallest quantity in the identified transaction loop;
update each respective transaction included in the identified transaction loop to remove the quantity from the respective transactions and thereby obtain a modified set of respective transactions; and
update the group of transactions to replace the respective transactions included in the identified transaction loop with the modified set of respective transactions and thereby obtain the updated group of transactions for input to the loop identifier model for identifying the next transaction loop.

14. The data processing apparatus according to claim 12 wherein:
the data processing apparatus is configured to automatically update the group of transactions to obtain the updated group of transactions and input the updated group of transactions to the loop identifier model to identify the next transaction loop, and optionally wherein the data processing apparatus is configured to repeat the operations of updating the group of transactions and inputting the updated group of transactions to the loop identifier model to identify further transaction loops; or
wherein the data processing apparatus is configured to update the group of transactions to obtain the updated group of transactions and input the updated group of transactions to the loop identifier model in response to receiving user confirmation for the identified transaction loop.

15. The data processing apparatus according to claim 1, wherein in response to receiving user rejection for the identified transaction loop, the data processing apparatus is configured to: generate second notification data indicative of another transaction loop, and output the second notification data to one or more of the client devices.

16. The data processing apparatus according to claim 1, wherein a number of transaction loops identifiable by the loop identifier model for a set of input transaction data is limited to a threshold number of transaction loops, and/or wherein a running time for the loop identifier model to identify transaction loops for a set of input transaction data is limited to a threshold time duration.

17. The data processing apparatus according to claim 1, wherein the data processing apparatus is configured to:
receive first transaction data uploaded from a first client device associated with a first entity, store the first transaction data to storage circuitry, and generate a first user interface accessible to the first client device for displaying the first transaction data; and
receive second transaction data uploaded from a second client device associated with a second entity, store the second transaction data to the storage circuitry, and generate a second user interface accessible to the second client device for displaying the second transaction data, and optionally:
wherein the data processing apparatus is configured to update the first transaction data to add new transactions and/or modify transactions in response to user inputs via the first user interface, and wherein the processing circuitry is configured to update the second transaction data to add new transactions and/or modify transactions in response to user inputs via the second user interface; and/or
wherein in response to an identified transaction loop comprising at least one transaction involving the first entity and at least one transaction involving the second entity, the data processing apparatus is configured to allow access via each of the first user interface and the second user interface to the notification data indicative of the identified transaction loop, and optionally
wherein for each entity involved in the identified transaction loop and having a registered account with an online service provided by the data processing apparatus, the data processing apparatus is configured to allow access to the notification data indicative of the identified transaction loop via a user interface associated with that entity, and optionally
wherein the notification data comprises a selectable user interface element for confirming the identified transaction loop, and wherein the data processing apparatus is configured to generate confirmation data for the identified transaction loop in response to receiving confirmation from each entity involved in the identified transaction loop having a registered account with the online service; and/or
wherein in response to an identified transaction loop comprising at least the first entity and the second entity, the data processing apparatus is configured to generate an online chat for enabling message exchange between at least the first entity and the second entity.

18. The data processing apparatus according to claim 1, wherein:
the data processing apparatus is configured to analyse the transaction data and generate a plurality of respective groups of transactions each corresponding to a different item type, and input each of the plurality of groups of transactions to the loop identifier model to identify a transaction loop for each of the plurality of groups of transactions; and/or wherein the group of transactions comprises transactions each corresponding to a same item type, a same location, and a time corresponding to a same time range.

19. A computer-implemented method comprising:
receiving, from client devices, transaction data indicative of properties for future transactions for exchange of physical items between entities, wherein the transaction data for a respective transaction is indicative of at least: identifiers for two entities; a type or name for an item to be exchanged; a quantity for the item to be exchanged; and location and time information for the transaction;
analysing the transaction data and generating a group of transactions corresponding to a same item type;
inputting the group of transactions corresponding to the same item type to a loop identifier model to identify at least one transaction loop comprising at least three respective transactions from the group of transactions;
generating notification data indicative of the transaction loop; and
outputting the notification data to one or more of the client devices.

20. A computer program comprising instructions which, when executed by a computer, cause the computer to perform the method according to claim 19.
